(19) United States
(12) Patent Application Publication
(10) Pub. No.: US 2010/0227522 A1
(43) Pub. Date: Sep. 9, 2010

(54) IMITATING NATURAL PLANT FIBER, PREPARATION METHOD THEREOF AND FABRIC MADE OF IT

(75) Inventors: Hung-jen CHEN, Taichung Hsien (TW); Tina HUANG, Taichung Hsien (TW)

Correspondence Address: HAMRE, SCHUMANN, MUELLER & LARSON, P.C., P.O. BOX 2902, MINNEAPOLIS, MN, 55402-0902, US

(73) Assignee: NOVEKO TRADING 2008 LLC, Budapest (HU)

(21) Appl. No.: 12/784,692

(22) Filed: May 21, 2010

Related U.S. Application Data
(63) Continuation-in-part of application No. PCT/CN2007/003339, filed on Nov. 27, 2007.

(51) Int. Cl. D03D 15/00; C08J 3/22; D02G 3/00; D01D 5/12

(52) U.S. Cl. 442/189; 523/351; 428/401; 264/164

(57) ABSTRACT

An imitating natural plant fiber, preparation method thereof and the fabric made of it are provided. The preparation method includes the following steps: rolling and milling the mixture of plural first polyolefine chips, constant thermoplastic elastomer (TPE) and plural microcapsules which encapsulate essential oil extracted from natural plant in the twin-screw extruder, thus plural masterbatches can be made; melting and mixing the above masterbatches and plural second polyolefine which is same as the first one, thus a composite can be made, wherein the final content of the microcapsules is 1-32% by weight; and producing fibers by spinning, cooling, heat stretching, and heat setting. The fiber and the fabric made of it have durable natural plant aroma.

### FIELD OF THE INVENTION

The present invention relates generally to an imitating natural plant fiber, the preparation method thereof and a fabric made from the fiber. More particularly, the present invention relates to compounding microcapsules having plant extracted essential oils encapsulated therein, thermoplastic elastomer (TPE) and polyolefine, and spinning to form a fiber, and weaving the fiber to form a fabric, such that the fiber or the fabric thereof has durable natural plant aroma.

### PRIOR ART

The magical power of aroma had been discovered in ancient civilization of 5000 years ago, and pursuing spiritual calm and mental and physical health, and even cosmetology maintenance had been described in the history of ancient “Four Great Ancient Civilizations”. The extracting methods and extracted plants used by the ancient people are slightly different from those used in modern times. In ancient aromatherapy, few plant essential oils had been used as essential oils, on the contrary, resin, essence, concentrated liquid, and balm had been widely used, and plants were used in spice, perfume, drug, and religious rituals. Ancient Egyptians even applied essence oil and resin of frankincense on the mummies to exhibit preservative effects.

By using nano microcapsule fibers made from natural plant essential oils, products can obtain effective aging control, and make up the deficiency in natural elements in the air, which can obtain auxiliary effects of emotion and mood.

In conventional technology, the essential oil products usually adopt incense or add artificial additives such as isopropanol to evaporate the essential oils into the air; however, it is easy to incur risk and loose the original effect of the essential oils. To encapsulate the essential oils in the microcapsules can allow the essential oils to be released under effective control, which is not only increasing the safety but also effectively controlling the aging effect. Fabrics are indispensable to human lives and are common; for example, most of the clothes such as air filter, screen window, hat, seat cushion, sleeping pad and shoe, and curtain are weaved from fibers. Since fabrics have been widely used by human beings and are relevant to human health, a lot of functional fabrics have been developed; for example, some techniques have been used to make fabrics having antibacterial and deodorization effects, to maintain human heath and comfortability, and some techniques have been used to make fabrics having plant aroma effects, to increase comfortability for use.

However, though fabrics with antibacterial and deodorization effects or fabrics with plant aroma effects have been known conventionally, most of them are realized by coating a layer of antibacterial and deodorization agents or aromatic agents on the fabric. Because the coated materials are vaporized rapidly, in the beginning, the antibacterial and deodorization effects or aroma effects are good, but within a short time, they will soon lose efficacy because of rapid evaporation. Furthermore, though there are techniques for incorporating the antibacterial agents in the fiber, usually the antibacterial effects cannot be exhibited since the antibacterial agents are embedded in the fiber. In particular, among the conventional techniques, a better technique for incorporating plant extracted essential oils in the fiber and keeping release of aroma for a long period of time had never been provided. Therefore, based on years of experience in developing fibers and fabrics, in addition to the fibers and fabrics with highly economic benefits and capable of generating negative ions and having antibacterial and deodorization functions, the inventors of the present invention also have been actively devoted in developing fibers with durable plant aroma.

After the development reached a certain level of results, in 2004 a patent application in connection with the fibers capable of generating negative ions and having antibacterial and deodorization effects was filed as Taiwan patent application No. 93129156, which has been allowed for patent. Besides, through many experiments and improvements, a new technique was generated and applied for patent as U.S. patent application Ser. No. 11/416,155. Recently, a novel technique in connection with an imitating natural plant fiber has reached a certain level of results through continuing researches and experiments, and thus the present application is presented.

There are techniques relating to a thermoplastic elastomer comprising plant essential oils in the art. For example, U.S. Pat. No. 6,673,857 relates to the research in the material components of thermoplastic elastomer, wherein the thermoplastic elastomer is used to manufacture articles such as toys. Nevertheless, the prior arts mentioned above are different from the present invention in technical features. The present invention is based on the achievements obtained from the inventor's continuing research and manufacturing experiences, and it is proved by experimental evidences that the present invention does have practical effects, which meets the requirements for a patent. The patent application is thus filed to protect the achievements of the inventors' research and development.

### SUMMARY OF THE INVENTION

The objective of the present invention is to provide a method for manufacturing an imitating natural plant fiber. The method is characterized in utilizing microcapsules having plant extracted essential oils encapsulated therein, thermoplastic elastomer (TPE) and polyolefine, compounding in a preferred ratio and spinning to obtain the fiber, such that the fiber is capable of releasing plant aroma.

The second objective of the present invention is to provide a fiber capable of generating durable plant aroma. The fiber is characterized in that the fiber has incorporated thermoplastic elastomer therein and comprises plural microcapsules, and the microcapsules have plant extracted essential oils encapsulated therein. The release of the essential oils is appropriately controlled by the thermoplastic elastomer, so as to achieve the purpose of keeping the fiber aromatic durably.

### DETAILED DESCRIPTION OF THE PREFERRED EMBODIMENT

### I. Basic Technical Features of the Present Invention

The present invention is focused on researching and testing fibers having imitating natural plant aroma. The basic technical feature is that fibers of the present invention are manufactured by compounding materials including microcapsules having plant extracted essential oils encapsulated therein, thermoplastic elastomer and polyolefine, so as to allow the fibers to have functions of releasing plant aroma durably and to be weaved to many kinds of fabrics, wherein the fabrics can be air filters, or shoe pads, or hats, or screen windows, or masks, or sleeping pads, or backrest cushions, or seat cushions, or curtains, or TV goggles.

### II. Fibers of the Present Invention

The fibers of the present invention are mainly produced from compounding microcapsules having plant extracted essential oils encapsulated therein, a predetermined amount of thermoplastic elastomer (TPE) and a predetermined amount of polyolefine (for example, polypropylene or polyethylene) together, and through spinning to form the fibers. Through the effects of the thermoplastic elastomer, the fibers of the present invention can stably release plant aroma for a long period of time and thus allow the fabrics weaved from the fibers to have practical functions.

In the first embodiment of the present invention, the fibers produced have a diameter of 0.005 mm˜5 mm (most preferably 0.01 mm˜3 mm). The microcapsules added are in an amount ranging from 1 to 32% by weight based on the total weight of the fiber.

The manufacturing method for the imitating natural plant fiber of the present invention comprises the following steps:

(a) preparing the following materials:

(a1) plural first polyolefine chips, 10%-80% by weight, as a substrate, the first polyolefine being able to be polypropylene chips with molecular weight of 3.15×10⁵ g/mole or polyethylene chips with molecular weight of 1.5˜2.5×10⁵ g/mole (as embodiments, the following tests of the present invention are explained by polypropylene);

(a2) plural microcapsules, 5%-50% by weight, each of the microcapsules having plant essential oils encapsulated therein, preferably the plant essential oils being extracted from natural plants; and

(a3) a thermoplastic elastomer (TPE or EPDM), 1%-80% by weight;

(b) compounding the plural first polyolefine chips, the plural microcapsules and a predetermined amount of the thermoplastic elastomer to form plural masterbatches by a twin-screw extruder;

(c) providing the plural masterbatches and plural second polyolefine is chips, wherein the second polyolefine is formed of the same material as the first polyolefine, and melting and mixing the plural masterbatches and the plural second polyolefine chips to form a composite material, such that the content of the plural microcapsules is 1-32 wt % based on the weight of the composite material; and

(d) subjecting the composite material to spinning, cooling, thermal stretching, and heat setting to form the fiber.

Wherein, the spinning temperature is within the range of 200° C.˜300° C. (in the actually operated examples of the present invention, the spinning temperature for polypropylene is 200° C.˜250° C. rise, and for polyethylene is 250° C.˜300° C.), the drafting factor is 3˜8 times (in the actually operated examples of the present invention, the drafting factor is 6 times), the heat stretching temperature is 100° C.˜160° C. (in the actually operated examples of the present invention, 100° C. hot water is used for stretching), and the heat setting temperature is 70° C.˜100° C.

The melt-spinning mentioned above is conducted by heating and melting the composite material, and extruding the melted material from spinning holes into air, while cooling in the air, winding at a constant speed, and solidifying while the melted composite material is thinning, a fiber is thus formed, and then executing thermal stretching to enhance mechanical properties of the fiber. In the melt-spinning process, the spinnable polymers obtained from a polymeric process at a temperature higher than the melting point thereof are extruded from the holes in the spinning plate, and then cooled and refined to silky solid, and winded at the same time.

### III. Embodiments of the Microcapsules and Plant Extracted Essential Oils of the Present Invention

To allow the fibers to generate durable plant aroma, the present invention utilizes microcapsules having plant extracted essential oils encapsulated therein, wherein the microcapsules are made of one or more materials selected from chitin, polyurethane elastomer, thermoplastic elastomer and tourmaline. By the technique of combining the microcapsules having plant essentials encapsulated therein with the thermoplastic elastomer, the present invention has the effects of generating durable aroma, and as shown in the following test results, the present invention actually exhibits the effects of generating durable aroma. In a preferred embodiment, each of the microcapsules can have more than two kinds of plant essential oils encapsulated therein, and by the interaction of the two different kinds of plant essential oils, the aromatic durability is even better.

In the present invention, the plant essential oil is extracted from a natural plant, and the natural plant is selected from one or more of lavender, lemon, hinoki, rosemary, eucalyptus, tea tree, sandalwood, bergamot, pine, jasmine, rose, chamomile, Ylang Ylang, basil, geranium, niaouli, cardamom, musk, myrrh, cinnamon, fennel, frankincense, citrus, peppermint, cedarwood, patchouli, palmarosa, clove, grapefruit, benzoin, ginger, citronella, and marjoram.

### IV. Test Examples of the Present Invention

In the test examples of the present invention, plural polypropylene chips with molecular weight of 3.15×10⁵ g/mole are used as the substrate. The plural polypropylene chips are 20% by weight based on the total weight. The microcapsules prepared are 50% by weight based on the total weight, and the plant essential oils encapsulated in each of the microcapsules are extracted from natural plants. The thermoplastic elastomer (TPE) prepared is 30% by weight based on the total weight. In this test example, the technical feature of the present invention resides in that the amount of the thermoplastic elastomer (30%) is larger than the amount of the polypropylene (20%), such that the microcapsules can be easily premixed with the polypropylene and the thermoplastic elastomer.

During manufacturing, the 20% by weight of polypropylene chips, the 50% by weight of microcapsules, and the 30% by weight of thermoplastic elastomer are compounded and granulated by a twin-screw extruder to form plural masterbatches. Then, the plural masterbatches and additional polypropylene chips are provided, and the masterbatches and the additional s polypropylene chips are compounded to a composite material, with the final content of the microcapsules is in an amount of 20% by weight based on the total weight of the composite material. Finally, the composite material is subjected to spinning, cooling, thermal stretching, and heat setting to form the fiber. In the above process, the spinning temperature is within 240° C., the drafting factor is 6 times, the thermal stretching temperature is 100° C.

To conduct specific tests, the fibers of the present invention are further weaved to a fabric; that is, plural fibers in warp direction and plural fibers in weft direction are weaved to form a fabric.

The test results of the cleaning ability and the aromatic durability of the fabrics with the imitating natural plant fibers of the present invention are listed as follows.

### (i) Analysis of Cleaning Ability

The sample size of this test is 101.6 mm×203.2 mm (4 in×8 in), the amount of fibers in warp direction distributed in an unit length is 42 stripe per inch, and the amount of fibers in weft direction distributed in an unit length is 34 stripe per inch. From Table 1, it is found that the web body of the present invention exhibits effective cleaning ability of the natural essential oils.

TABLE 1

| | | Testing | Testing | Testing | Testing |
|---|---|---|---|---|---|
| | CAS | result | limit | result | limit |
| Compound name | number | (ug) | (ug) | (ug/g) | (ug/g) |
| Acetone | 000067-64-1 | 0.38 | 0.1 | 0.25 | 0.06 |
| 2-methylpentane | 000107-83-5 | 0.11 | 0.1 | 0.07 | 0.06 |
| 1,1-Dimethylallene | 000598-25-5 | 0.48 | 0.1 | 0.31 | 0.06 |
| 2,4-dimethylHexane | 000589-43-5 | 0.22 | 0.1 | 0.14 | 0.06 |
| 3,3-dimethylHexane | 000563-16-6 | 0.14 | 0.1 | 0.09 | 0.06 |
| 2,3-dimethylHexane | 000584-94-1 | 0.16 | 0.1 | 0.11 | 0.06 |
| 4-methylHeptane | 000589-53-7 | 0.12 | 0.1 | 0.07 | 0.06 |
| 2,4- | 002213-23-2 | 0.18 | 0.1 | 0.12 | 0.06 |
| Dimethylheptane | | | | | |
| 4-methylOctane | 002216-34-4 | 0.13 | 0.1 | 0.08 | 0.06 |
| PARA CYMENE | 000099-87-6 | 5.62 | 0.1 | 3.64 | 0.06 |
| .alpha.-pinene | 000080-56-8 | 36.74 | 0.1 | 23.78 | 0.06 |
| Fenchene | 000471-84-1 | 0.19 | 0.1 | 0.12 | 0.06 |
| Camphene | 000079-92-5 | 2.06 | 0.1 | 1.33 | 0.06 |
| SABINENE | 003387-41-5 | 21.76 | 0.1 | 14.09 | 0.06 |
| Pseudopinene | 000127-91-3 | 164.98 | 0.1 | 106.78 | 0.06 |
| n-Octanal | 000124-13-0 | 0.35 | 0.1 | 0.23 | 0.06 |
| p-Cymene | 000099-87-6 | 6.58 | 0.1 | 4.26 | 0.06 |
| LIMONENE | 000138-86-3 | 213.81 | 0.1 | 138.39 | 0.06 |
| Gamma-Terpinene | 000099-85-4 | 29.63 | 0.1 | 19.18 | 0.06 |
| Terpinolene | 000586-62-9 | 1.85 | 0.1 | 1.20 | 0.06 |
| D-3-carene | 013466-78-9 | 0.98 | 0.1 | 0.64 | 0.06 |
| Isopropenyltoluene | 026444-18-8 | 12.83 | 0.1 | 8.30 | 0.06 |

### (ii) Aging Analysis

The present invention conducted the following 8 dynamic aging analyses, and from the test results, it is shown that the present invention has long term durability. The test method is operated by putting the samples to be tested (size: 23.5 CM×36.5 CM) in an air cleaner (wind speed: 3.3 m³/min), and after turning on the air cleaner, in a predetermined time of the experiment, cutting an appropriate area of the web body of the present invention and putting in a gas collecting bag, after stabilizing for 6 hours, collecting the air, and analyzing the sample by a thermal desorption device connecting with a gas phase chromatography mass spectrometry (GC/MS).

(1) Aging analysis of 0 hour, the results are listed in the following table:

| | | 0 hour Without | | |
|---|---|---|---|---|
| | | turning on the | Testing | |
| Compound name | CAS number | cleaner | limit | Unit |
| .ALPHA.-PINENE | 000080-56-8 | 0.026 | 0.0040 | ug/cm² |
| sabinene | 003387-41-5 | 0.025 | 0.0040 | ug/cm² |
| .BETA.-PINENE | 018172-67-3 | 0.160 | 0.0040 | ug/cm² |
| LIMONENE | 000138-86-3 | 0.478 | 0.0040 | ug/cm² |
| .gamma.-Terpinene | 000099-85-4 | 0.050 | 0.0040 | ug/cm² |
| Naphthalene | 000091-20-3 | 0.011 | 0.0040 | ug/cm² |
| neral | 000106-26-3 | 0.019 | 0.0040 | ug/cm² |
| GERANIAL | 000141-27-5 | 0.014 | 0.0040 | ug/cm² |
| 2,5-Cyclohexadiene-1, | 000844-51-9 | 0.264 | 0.0040 | ug/cm² |
| 4-dione, 2,5-diphenyl- | | | | |

(2) Aging analysis of 600 hours, the results are listed in the following to table:

| | | 600 hours | Testing | |
|---|---|---|---|---|
| Compound name | CAS number | after turn on | limit | Unit |
| .ALPHA.-PINENE | 000080-56-8 | 0.013 | 0.0040 | ug/cm² |
| sabinene | 003387-41-5 | 0.011 | 0.0040 | ug/cm² |
| .BETA.-PINENE | 018172-67-3 | 0.086 | 0.0040 | ug/cm² |
| PARA-CYMENE | 000099-87-6 | 0.011 | 0.0040 | ug/cm² |
| LIMONENE | 000138-86-3 | 0.257 | 0.0040 | ug/cm² |
| .gamma.-Terpinene | 000099-85-4 | 0.027 | 0.0040 | ug/cm² |

(3) Aging analysis of 800 hours, the results are listed in the following table:

| | | 800 hours | Testing | |
|---|---|---|---|---|
| Compound name | CAS number | after turn on | limit | Unit |
| .alpha.-PINENE | 000080-56-8 | 0.0057 | 0.0040 | ug/cm² |
| .BETA.-PINENE | 000127-91-3 | 0.0177 | 0.0040 | ug/cm² |
| LIMONENE | 000138-86-3 | 0.0218 | 0.0040 | ug/cm² |
| 2,6-di-butyl-2,5-cyclo- | 000719-22-2 | 0.0063 | 0.0040 | ug/cm² |
| hexadiene-1,4-dione | | | | |

(4) Aging analysis of 1200 hours, the results are listed in the following table:

| | | 1200 hours | Testing | |
|---|---|---|---|---|
| Compound name | CAS number | after turn on | limit | Unit |
| .ALPHA.-PINENE | 000080-56-8 | 0.0070 | 0.0040 | ug/cm² |
| .BETA.- | 000555-10-2 | 0.0053 | 0.0040 | ug/cm² |
| PHELLANDRENE | | | | |
| .BETA.-PINENE | 000127-91-3 | 0.0483 | 0.0040 | ug/cm² |
| LIMONENE | 000138-86-3 | 0.0777 | 0.0040 | ug/cm² |
| .gamma.-Terpinene | 000099-85-4 | 0.0080 | 0.0040 | ug/cm² |

(5) Aging analysis of 2500 hours, the results are listed in the following table:

| | | | 2500 hours | |
|---|---|---|---|---|
| NO. | Compounds | CAS NO. | after turn on | Unit |
| 1 | .beta.-PINENE | 000127-91-3 | 0.0041 | ug/cm² |

(6) Aging analysis of 3000 hours, the results are listed in the following table:

| | | | 3000 hours | |
|---|---|---|---|---|
| NO. | Compounds | CAS NO. | after turn on | Unit |
| 1 | .beta.-PINENE | 000127-91-3 | 0.0038 | ug/cm² |

(7) Aging analysis of 3500 hours, the results are listed in the following table:

| | | | 3500 hours | |
|---|---|---|---|---|
| NO. | Compounds | CAS NO. | after turn on | Unit |
| 1 | .beta.-PINENE | 000127-91-3 | 0.0044 | ug/cm² |

(8) Aging analysis of 4500 hours, the results are listed in the following table:

| | | | 4500 hours | |
|---|---|---|---|---|
| NO. | Compounds | CAS NO. | after turn on | Unit |
| 1 | .beta.-PINENE | 000127-91-3 | 0.0044 | ug/cm² |

(iii) Aging Analysis of Preservation:

As shown in the results of Table 2, the present invention still has effective aroma effects after being placed in ambient environment for two years, which is sufficient to prove that the manufacturing method and the fibers made therefrom can ensure the aromatic durability of the essential oils added in the microcapsules.

TABLE 2
Test for the aromatic durability of the
microcapsules added with essential oils

| Test item | Result (Initiation) | Result (test after two years) |
|---|---|---|
| smell function | 3.4 | 4.0 |
| evaluation | | |

### (iv) Analysis of the Physical Conditions of the Present Invention:

The analysis results are listed in the following table.

| Fabric raw material | | | | PP (Polypropylene) | | | |
|---|---|---|---|---|---|---|---|
| Test item | | | | Result | | UNIT | METHOD |
| Fiber fineness | | | | 0.18 | | mm | ASTM D2130 |
| Mesh | Warp | | | 42 | | Inch | ASTM D3775 |
| | Weft | | | 34 | | Inch | ASTM D3775 |
| Weight per square meter | | | | 80 | | g/m² | ASTM D3776 |
| Thickness of fabric | | | | 0.21 | | mm | ASTM D5729 |
| Bursting strength of fabric | | | | 26 | | Kgf/cm² | ASTM D3786 |
| Breaking strength | Warp | | | 47 | | Kgf/cm² | ASTM D4632 |
| | Weft | | | 45 | | Kgf/cm² | ASTM D4632 |
| Stretch properties of fabric | | | | 16 | | (%) | ASTM D2594 |
| Shrinkage 80° C. | | | | 1.0 | | % | ASTM D2259 |
| Shrinkage 90° C. | | | | 1.5 | | % | ASTM D2259 |
| Yarn tear strength | | | | 3 | | kg | ASTM D2256 |
| Air permeability | | | | 465 | | cm³/cm²/s | ASTM 737 |
| Filtration | 1 pc | 2 pcs | 3 pcs | 4 pcs | 5 pcs | E % | ASHRAE52.1-1992 |
| efficiency (E %) | 30 | 61 | 79 | 87 | 97 | | (Weight Arrestance) |
| | | | | | | | 500 CFM |
| Pressure | 1 pc | 2 pcs | 3 pcs | 4 pcs | 5 pcs | Inch- | 1 Inch-Watch = |
| difference | | | | | | watch | 250 Pa |
| 500 CFM | 0.003 | 0.003 | 0.031 | 0.068 | 0.071 | | |
| 1000 CFM | 0.030 | 0.045 | 0.075 | 0.111 | 0.143 | | |
| 1500 CFM | 0.071 | 0.110 | 0.140 | 0.185 | 0.235 | | |
| 2000 CFM | 0.125 | 0.180 | 0.240 | 0.300 | 0.370 | | |
| 2500 CFM | 0.182 | 0.265 | 0.355 | 0.440 | 0.540 | | |
| 3000 CFM | 0.251 | 0.375 | 0.485 | 0.605 | 0.745 | | |

### V. Conclusion

The present invention, when added with the microcapsules including essential oils, since the thermoplastic elastomer is added simultaneously, through the function of the elastomer, the essential oils can be prevented from rapid evaporation. Thus, the essential oils can be released in a manner of closing to constant amount, which can prevent wasting and increase durability. Furthermore, by the adjustment of the ratios of each component and the process of secondary compounding, the present invention can be put into practice, and can actually achieve the expected effects.

What mentioned above is only feasible example of the present invention, which is not used to limit the patent scope of the present invention. All variations and equivalents made based on the contents, features and spirits of the claims below should be within the patent scope of the present invention.

What is claimed is:

1. A manufacturing method for an imitating natural plant fiber, comprising the following steps:
(a) preparing the following materials:
(a1) plural first polyolefine chips, 10%-80% by weight, as a substrate;
(a2) plural microcapsules, 5%-50% by weight, each of the microcapsules having at least one plant essential oil encapsulated therein; and
(a3) a thermoplastic elastomer (TPE), 1%-80% by weight;
(b) compounding the plural first polyolefine chips, the plural microcapsules and the thermoplastic elastomer to form plural masterbatches;
(c) providing the plural masterbatches and plural second polyolefine chips, the second polyolefine being formed of the same material as the first polyolefine, and melting and mixing the plural masterbatches and the plural second polyolefine chips to form a composite material, such that the content of the plural microcapsules is in the amount of 1-32 wt % based on the weight of the composite material; and
(d) processing the composite material into the fiber.

2. The manufacturing method according to claim 1, wherein the first polyolefine and the second polyolefine are both polypropylene.

3. The manufacturing method according to claim 2, wherein the molecular weight of the polypropylene is 3.15×10⁵ g/mole.

4. The manufacturing method according to claim 1, wherein the first polyolefine and the second polyolefine are both polyethylene.

5. The manufacturing method according to claim 4, wherein the molecular weight of the polyethylene is 1.5˜2.5×10⁵ g/mole.

6. The manufacturing method according to claim 1, wherein the microcapsules are made of at least one material selected from chitin, polyurethane elastomer, thermoplastic elastomer and tourmaline.

7. The manufacturing method according to claim 1, wherein in the step (d), the composite material is subjecting to spinning, cooling, thermal o stretching, and heat setting to form the fiber.

8. The manufacturing method according to claim 7, wherein the spinning temperature is 240° C., the heat stretching temperature is 100° C., and the heat setting temperature is 90° C.

9. The manufacturing method according to claim 1, wherein the plant essential oil is extracted from a natural plant.

10. The manufacturing method according to claim 9, wherein the natural plant is selected from at least one of lavender, lemon, hinoki, rosemary, eucalyptus, tea tree, sandalwood, bergamot, pine, jasmine, rose, chamomile, Ylang Ylang, basil, geranium, niaouli, cardamom, musk, myrrh, cinnamon, fennel, frankincense, citrus, peppermint, cedarwood, patchouli, palmarosa, clove, grapefruit, benzoin, ginger, citronella, and marjoram.

11. The manufacturing method according to claim 1, wherein in the step (a), the amount of the thermoplastic elastomer is larger than the amount of the plural first polyolefine chips.

12. The manufacturing method according to claim 9, wherein in the step (a), the amount of the thermoplastic elastomer is 30% by weight, the amount of the plural first polyolefine chips is 20% by weight, and the amount of the microcapsules is 50% by weight.

13. A fiber produced by the manufacturing method according to claim 1, wherein the diameter of the fiber is 0.005 mm˜5 mm, the fiber includes the plural microcapsules, and the plant essential oil is encapsulated inside each of the microcapsules.

14. A fabric produced from the fiber according to claim 13, wherein the fabric comprises plural fibers in warp direction and plural fibers in weft direction weaved with each other.

15. The fabric according to claim 14, wherein the fabric is selected from one of air filter, shoe pad, hat, screen window, curtain, mask, sleeping pad, backrest cushion, seat cushion and TV goggle.
